(19) United States
(12) Patent Application Publication
(10) Pub. No.: US 2012/0204257 A1
(43) Pub. Date: Aug. 9, 2012

(54) DETECTING FRAUD USING TOUCHSCREEN INTERACTION BEHAVIOR

(75) Inventors: BRIAN M. O'CONNELL, RTP, NC (US); KEITH R. WALKER, AUSTIN, TX (US)

(73) Assignee: INTERNATIONAL BUSINESS MACHINES CORPORATION, ARMONK, NY (US)

(21) Appl. No.: 13/447,848

(22) Filed: Apr. 16, 2012

Related U.S. Application Data
(63) Continuation-in-part of application No. 11/279,202, filed on Apr. 10, 2006.

(51) Int. Cl. G06F 21/00; G06F 7/04

(52) U.S. Cl. 726/19; 726/16; 726/17

(57) ABSTRACT

A processor can receive data indicative of interactions between a user and a touchscreen-equipped electronic device. The processor can compare a behavior pattern in the received data and a behavior pattern in previously stored data contained within a user profile for a human. The processor can generate a score indicative of a likelihood that the behavior pattern in the received data matches the behavior pattern in the previously stored data. Responsive to the generated score being below a threshold, the processor can generate an indication of a possible fraudulent action due to the user having a high likelihood of not being the human.

### CROSS-REFERENCE TO RELATED APPLICATIONS

This application is a continuation-in-part of U.S. patent application Ser. No. 11/279,202, filed Apr. 10, 2006 (pending).

### TECHNICAL FIELD

The present invention relates to the field of user authentication and, more particularly, to detecting fraud transparently determining user identity using data of user interactions with a touchscreen-equipped device.

### BACKGROUND

A touchscreen can be an electronic visual display which can detect the presence and location of a touch within a display area. The term “touch” can refer to touching the display of a device with a finger or hand. Touchscreens can also sense other passive objects, such as a stylus. Touchscreens can be common in devices such as all-in-one computers, tablet computers, and smartphones. The touchscreen can have two main attributes. First, it can enable direct interaction with what is displayed, rather than indirect interaction with a pointer controlled by a mouse or touchpad. Secondly, it can allow interaction without requiring any intermediate device that would need to be held in the hand. Such displays can be attached to computers, or to networks as terminals. They can play a prominent role in the design of digital appliances such as personal digital assistants (PDAs), satellite navigation devices, mobile phones, and video games.

Devices with a touchscreen are becoming increasingly utilized in electronic commerce (e.g., e-commerce) transactions. For example, many smartphone users often purchase items through the use of a Web browser on the smartphone. Traditional approaches to protect businesses and users from e-commerce fraud rely on positively identifying the user in one or more transparent ways. One traditional method that can be utilized is user identification via keyboard/mouse interaction with a device. For example, a user often interacts with a Web site in similar way from session to session. That is, user habits can be tracked and a profile can be created to uniquely identify a user. Methods have been disclosed for mouse/keyboard interactions, but due to the disparate nature of the interaction styles, those methods are not applicable to touchscreen devices.

One known solution can be to require a security code (3 or 4 digit non-imprinted number on credit card) with every purchase, but this provides no protection when the code is entered during a “phishing” process. Another solution can be to require operator “call back,” but phone numbers can be quickly setup and taken down with no audit trail (e.g., Voice over IP). Further, it can be expensive to employ personnel to make live phone calls, and customers must be near a phone to receive a call back. For Internet-consumable goods, customers are not treated to the instant satisfaction of their purchase, thus lowering overall customer satisfaction. Lastly, requiring that the user fully validate his or her credentials with every purchase can result in an extra step for the user and can lower overall customer satisfaction.

### SUMMARY

In at least one embodiment, there is a method for detecting fraudulent user interactions with a touchscreen-equipped electronic device. In the method, a processor can receive data indicative of interactions between a user and a touchscreen-equipped electronic device. The processor can compare a behavior pattern in the received data and a behavior pattern in previously stored data contained within a user profile for a human. The processor can generate a score indicative of a likelihood that the behavior pattern in the received data matches the behavior pattern in the previously stored data. Responsive to the generated score being below a threshold, the processor can generate an indication of a possible fraudulent action due to the user having a high likelihood of not being the human.

In at least one embodiment, there is a system for detecting fraudulent user interactions with a touchscreen-equipped electronic device including one or more processors, one or more computer-readable memories and one or more computer-readable tangible storage devices. The system can include program instructions, stored on at least one of the one or more storage devices for execution by at least one of the one or more processors via at least one of the one or more memories, to receive data indicative of interactions between the user and the touchscreen-equipped electronic device. The system can include program instructions, stored on at least one of the one or more storage devices for execution by at least one of the one or more processors via at least one of the one or more memories, to compare a behavior pattern in the received data and a behavior pattern in previously stored data contained within a user profile for a human. The system can include program instructions, stored on at least one of the one or more storage devices for execution by at least one of the one or more processors via at least one of the one or more memories, to generate a score indicative of a likelihood that the behavior pattern in the received data matches the behavior pattern in the previously stored data. The system can include program instructions, stored on at least one of the one or more storage devices for execution by at least one of the one or more processors via at least one of the one or more memories, responsive to the generated score being below a threshold, to generate an indication of a possible fraudulent action due to the user having a high likelihood of not being the human.

In at least one embodiment, there is a computer program product for detecting fraudulent user interactions with a touchscreen-equipped electronic device. The computer program product can include one or more computer-readable tangible storage devices. The computer program product can include program instructions, stored on at least one of the one or more storage devices, to receive data indicative of interactions between the user and the touchscreen-equipped electronic device. The computer program product can include program instructions, stored on at least one of the one or more storage devices, to compare a behavior pattern in the received data and a behavior pattern in previously stored data contained within a user profile for a human. The computer program product can include program instructions, stored on at least one of the one or more storage devices, to generate a score indicative of a likelihood that the behavior pattern in the received data matches the behavior pattern in the previously stored data. The computer program product can include program instructions, stored on at least one of the one or more storage devices, responsive to the generated score being below a threshold, to generate an indication of a possible fraudulent action due to the user having a high likelihood of not being the human.

### BRIEF DESCRIPTION OF THE SEVERAL VIEWS OF THE DRAWINGS

FIG. 1 is a schematic diagram illustrating a set of processes transparently determining user identity based on data of user interactions with a touchscreen-equipped device during a browser session in accordance with an embodiment of the inventive arrangements disclosed herein.

FIG. 2 is a schematic diagram illustrating a method for transparently determining user identity based on data of user interactions with a touchscreen-equipped device during a browser session in accordance with an embodiment of the inventive arrangements disclosed herein.

FIG. 3 is a schematic diagram illustrating a system for transparently determining user identity based on data of user interactions with a touchscreen-equipped device during a browser session in accordance with an embodiment of the inventive arrangements disclosed herein.

FIG. 4 is a schematic diagram illustrating an exemplary computing device in accordance with an embodiment of the inventive arrangements disclosed herein.

### DETAILED DESCRIPTION

Embodiments of the present invention provide a solution for transparently determining user identity during a browser session based on user interactions with a device having a touchscreen. In embodiments of the present invention, interaction data of devices having a touchscreen can be unobtrusively communicated to an authentication entity to verify the identity of a returning internet user based upon previous user interaction(s) with their browser(s). Embodiments of the present invention can be a component of a secondary authentication method in a “Two Factor” authentication system. Disclosed embodiments of methods cannot, by themselves, authenticate a user. However, when used in conjunction with a primary authentication method, such as a username and password, disclosed embodiments of methods can result in increased authentication strength.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium (also referable to as a storage device or a computer-readable, tangible storage device) may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

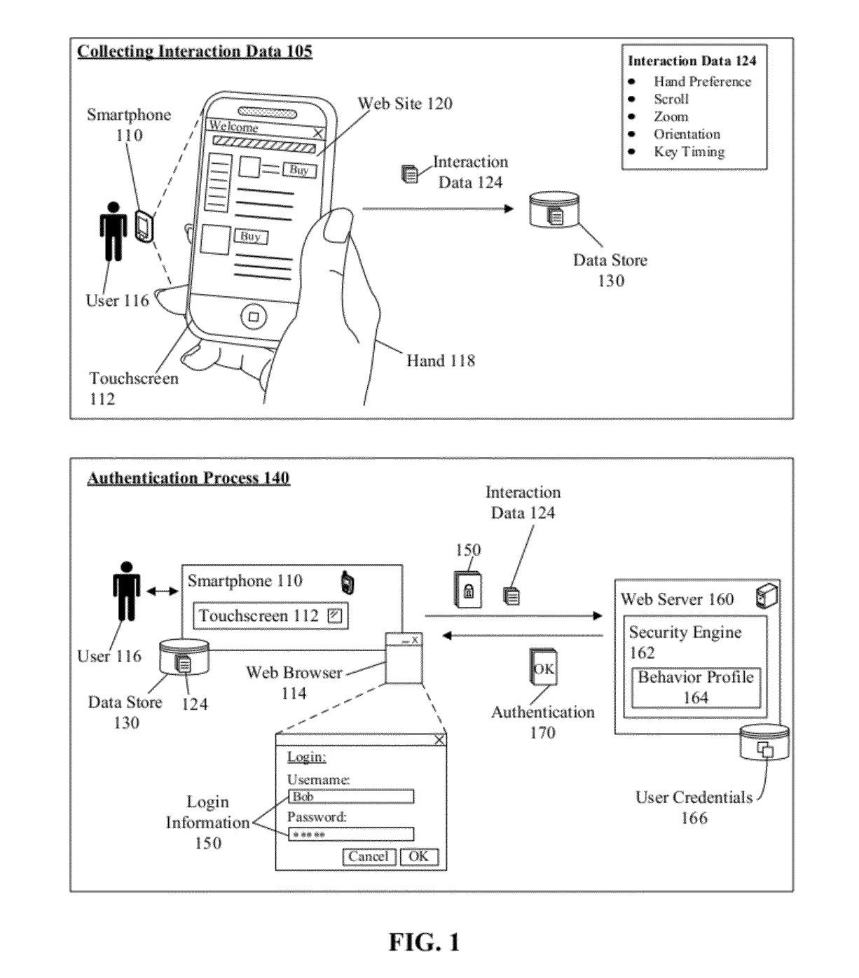

FIG. 1 is a schematic diagram illustrating a set of processes 105, 140 transparently determining user identity based on data of user interactions with a touchscreen-equipped device during a browser session in accordance with an embodiment of the inventive arrangements disclosed herein. Processes 105, 140 can be performed in the context of method 200 and system 300. In process 105, a user 116 can interact with a Web site 120 via a client touchscreen device 110. Client touchscreen device 110 can be a touchscreen 112 enabled device, such as a smartphone, permitting user 116 to use hand 118 to interact with site 120. As user 116 browses site 120, interaction data 124 can be collected and persisted within data store 130. That is, interaction data 124 (e.g., scrolling/zooming actions) indicative of user interactions with client computing device 110 having touchscreen 112 during a browser session can be collected. Collected data (e.g., data 124) can be submitted during authentication process 140 to verify user identity. In process 140, user provided login information 150 can be communicated with interaction data 124 to authenticate user 116. That is, data 124 can be utilized within a “two factor” authentication process to uniquely identify user 116. It should be appreciated that the solution can be an active or a passive authentication solution. For example, embodiments of the present invention can be utilized to continuously (e.g., periodically) confirm a user identity throughout a browser session.

A browser session can be a semi-permanent interactive information interchange between client touchscreen device 110 and a Web provider entity (e.g., Web server 160). Process 140 can be performed at any time during a browser session. That is, data 124 can be collected during anonymous browsing, at login time, post-login, and the like. A browser session can be associated with online activities including, but not limited to, electronic funds transfer, supply chain management, Internet marketing, online transaction processing, electronic data interchange (EDI), inventory management, social networking, entertainment activities (e.g., viewing streaming media), and the like.

It should be understood that data 124 can be collected in a number of ways, consistent with various embodiments of the disclosure. In different embodiments, interaction data 124, such as orientation data, can be pushed from the client touchscreen device 110 (i.e., when additional authentication is needed to access a function of a web application, code from the web application executing in the browser 114 can trigger input handler 333 to convey orientation data to the server 160, for example) or pulled from device 110 (i.e., an application program interface (API) or other standardized interfacing mechanism can be established for enabling server 160 to pull interaction data 124, like orientation data, from the input handler 333 of device 110 or from a memory space of device 110 where interaction data 124 is exposed to the server 160). Specifics of the conveyance of orientation data (or any of the interaction data 124) from client touchscreen device 110 to the web server 160 can vary from implementation to implementation, and the scope of the disclosure is not to be limited in this regard.

As used herein, interaction data 124 can be behavioral data associated with Web site 120 usage. Data 124 can include, but is not limited to, hand preference, scroll actions, zoom actions, screen orientation, key timing, and the like. In one instance, interaction data 124 can include habitual mannerism data such as data of interaction with interface widgets in web browser 114. In this instance, data 124 can include a textbox submit preference. For example, data 124 can indicate whether user 116 utilizes an enter key or an interface element (e.g., Submit button) in web browser 114 to submit data on site 120.

As used herein, screen orientation can be a horizontal or vertical orientation associated with client touchscreen device 110. Mobile embodiments of client touchscreen device 110 (e.g., smartphones) can support screen orientation changes. That is, rotation of client touchscreen device 110 can trigger the content of site 120 to change orientation. For example, when user 116 rotates the client touchscreen device 110 from a vertical position to a horizontal position, the content of site 120 can be presented in landscape instead of portrait. User preference in addition to Web site 120 design can dictate when and how often user 116 can change orientation. In one embodiment, interaction data 124 can be used to track which sections (e.g. pages, page portions) user 116 prefers to view in landscape or portrait. In the embodiment, data 124 can further be used to track the number of orientation changes and/or speed of change. In one instance, an accelerometer can be utilized to determine screen angle and/or rotational orientation in three dimensions. For example, when client touchscreen device 110 is held slightly askew (e.g., as shown in process 105), interaction data 124 can be utilized to track offset (from three dimensional axes) values.

Hand preference can be information associated with handedness of user 116. For example, user 116 can utilize right hand 118 to interact with site 120. Hand preference can be tracked throughout a browser session, indicating user habits while browsing site 120. In one embodiment, data 124 can be used to track finger preference based on sensors associated with touchscreen 112. In another embodiment, in addition to the number of fingers used for typing, server 160 can also identify the primary or common finger(s) used for typing (whether it be a user's thumb, index finger, and the like) based on the finger input width. Detecting finger preference may assume that a surface area of impact on a touch screen changes appreciably with different finger uses and/or may assume that different levels of pressure are associated with use of different fingers. For example, most touch screen devices 110 have sufficient sensors for impact sensitivity to at least distinguish between a thumb and a set of fingers. Touch orientation relative to the touchscreen 112 (based on angles of impact) can also vary based on finger usage, depending on a manner in which the client touchscreen device 110 is held. Regardless, detected interaction data can be conveyed over a network between device 110 and server 160, such as through a push or pull methodology.

Devices with a touchscreen can provide a different interaction with keyboards than traditional computers (e.g., virtual keyboards). Depending on device physical size, a user can elect to type with one or more fingers. For example, smaller devices can force some individuals to use a single finger, while other users can use two fingers. Determining typing style can be performed on a client device (e.g., client touchscreen device 110) and/or on a server (e.g., Web server 160). Detection of number of fingers can be achieved by input handler 333 calculating the time between touches of keys that are far apart on touchscreen 112, as defined by configurable parameters of input handler 333. For example, when at least four keys intervene between a set of keys, that set of keys can be considered far apart in one embodiment. Different thresholds can be established for vertical, horizontal, and diagonal distances between keys, in one embodiment, for purposes of determining whether keys are far apart as part of a keystroke timing computation. After being captured by input handler 333, the time between touches of keys that are far apart on touchscreen 112 can be included in interaction data 124, which interaction data 124 can be conveyed over a network to server 160.

In one embodiment, key sliding can be used to identify a user. Key sliding is an interaction in which a user can use two fingers and slide one finger to the next letter before releasing the previous letter being typed by the other finger. In one embodiment, key sliding can be measured by looking at the rate of incoming letters, where either input handler 333 or server 350 can perform the measurement calculations given raw data captured from user input. This method can also extend to the nowadays popular text input method of SWYPE™ in which a user can use a single finger and slide it across the keyboard, hitting the letters that make up the word he or she wishes to type in the order that they appear in the desired word. In one embodiment, key stroke timing can be utilized identify to key sliding patterns unique to a user.

The manner in which a user triggers a zoom action can help identify the user. Zoom actions can be triggered from an orientation change, a zoom gesture (e.g., pinch gesture), a menu item, a toolbar widget, and the like. For example, in some situations, a skilled user can achieve the necessary zoom by simply rotating the screen to landscape. In one instance, a double tap on touchscreen 112 can trigger a zoom action which can be recorded in interaction data 124. In another instance, the direction of a zoom gesture while pinching can be tracked, which can assist in creating a user-specific gesture for use in identifying the user. For example, some users commonly employ a diagonal gesture, while others can use an up/down gesture. In yet another instance, commonly used fingers can be used to identify a user's zooming style. For example, based on finger width (e.g., thumbs vs. other fingers), fingers used to trigger a zoom action can be determined.

It should be appreciated that a plug-in component (e.g., a plug-in to browser 114) can be utilized to obtain and record gesture specific data. In one example, such a plug-in component can be utilized when client side technologies (e.g., JAVASCRIPT) do not support granular gesture detection.

Similar to zooming actions, tracking scrolling behaviors can help identify the user. In one instance, finger position when scrolling can be used to identify the user. In this instance, the portion of the screen used for performing the scrolling action can be used to determine finger usage. The speed at which a user scrolls can be detected as part of the identification process. For example, the tendency to over scroll and “bounce” the screen can be detected. In one embodiment, the finger used can identify the hand preference. For example, if a large impression on the touchscreen is detected on the left hand side of the screen, it can indicate left hand thumb scrolling. It should be appreciated that other finger/hand combinations can likewise be discerned.

The aforementioned methods of measuring interaction data 124 that can be utilized to complete a behavior profile 164 (which can be stored in user credentials database 166) is not intended to be limiting. Other types of interaction data 124 are contemplated. In one embodiment, interaction data 124 can be captured and recorded by input handler 333, conveyed over a network, and received by web server 160, which processes this interaction data 124 and records this interaction data 124 within database 166.

In process 140, user 116 can provide login information 150 during a login process. In one embodiment, data 124 can be automatically communicated to Web server 160 during a login process. Information 150 and data 124 can be communicated as separate data entities or can be conveyed as a single data set. Engine 162 can evaluate information 150 to determine a match with user credentials stored in user credentials database 166. When a match does not occur, engine 162 can perform traditional authentication failure procedures (e.g., authentication failure notification).

When a match does occur, engine 162 can assess data 124 against behavior profile 164 to verify whether a behavior pattern in data 124 matches a behavior pattern in behavior profile 164. The assessment can generate a pattern matching score (e.g., confidence score) indicating the likelihood the user can be verified by behavior in use of client computing device 110 having touchscreen 112. In one instance, the score can be evaluated against a threshold value which can result in an authentication success or failure. Based on authentication result, engine 162 can perform necessary security actions to protect user 116 and/or server 160. In one instance, if data 124 is similar to profile 164, the engine 162 can convey authentication 170 which can authenticate the user. For example, user 116 can be presented with site 120 and/or user specific pages (e.g., account page, wishlist page, etc).

In one embodiment, when authentication is successful, interaction data 124 can be utilized to enhance the accuracy of behavior profile 164. In the embodiment, interaction data 124 can be analyzed and behavior patterns can be extracted which can be added to behavior profile 164. That is, data 124 can be utilized to create and/or improve a baseline behavior (e.g., behavior profile) associated with client computing device 110 equipped with touchscreen 112.

In another instance, if a behavior pattern in data 124 is dissimilar to a behavior pattern in profile 164, engine 162 can execute security actions. In this instance, security actions can include, authentication failure notification, presenting additional credential challenges, and the like. For example, a security question Web page can be presented within browser 114 to verify user identity.

Drawings presented herein are for illustrative purposes only and should not be construed to limit the invention in any regard. It should be understood that embodiments of client touchscreen device 110 can include mobile computing devices such as mobile phones and tablet computing devices. It should be appreciated that any combination of interaction data 124 can be utilized in identifying user 116. It should be understood that data 124 can be utilized at any time during a browser session to verify user identity. For instance, data 124 can be communicated when a user initiates an e-commerce transaction (e.g., purchase). It should be understood that process 140 can be performed at the beginning of a browser session, at purchase time, and the like. The disclosure can be utilized to assist in user validation with any e-commerce related transaction including, but not limited to, account setting changes, payment information changes, and the like.

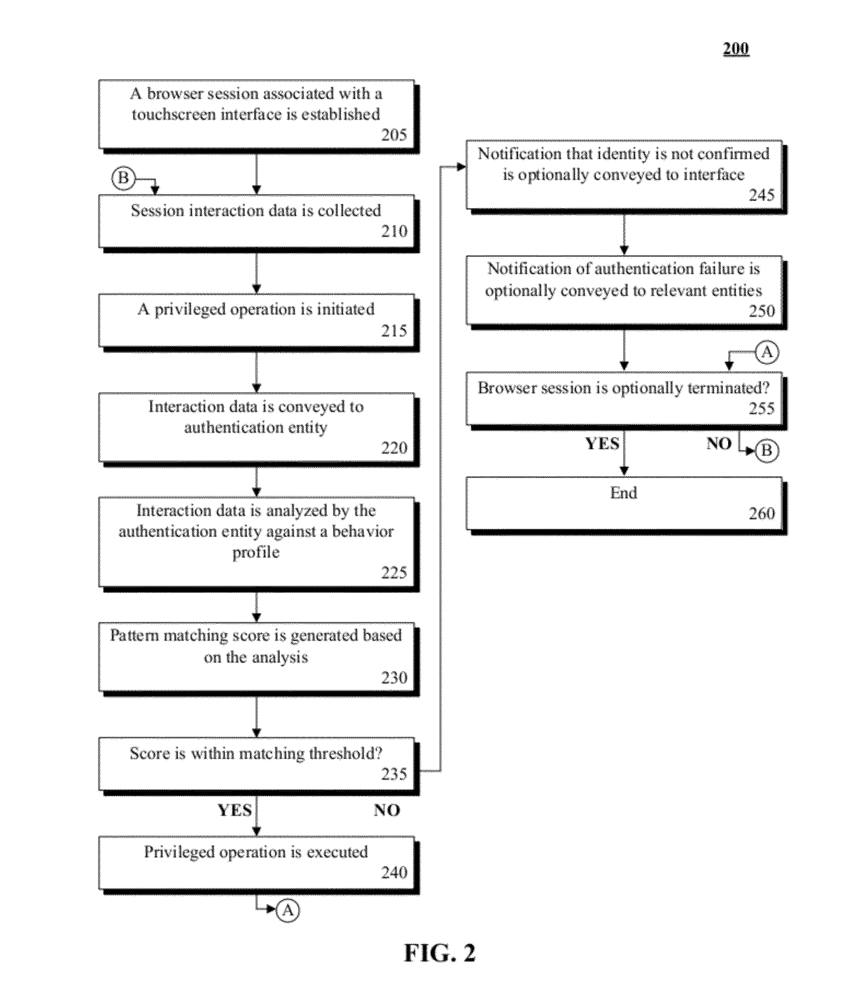

FIG. 2 is a schematic diagram illustrating a method 200 for transparently determining user identity based on data of user interactions with a touchscreen-equipped device during a browser session in accordance with an embodiment of the inventive arrangements disclosed herein. Method 200 can be performed in the context of processes 105, 140 and/or system 300. In method 200, web server 370 can verify a user as part of a two factor authentication process utilizing interaction data collected during a browser session. Input handler 333 can collect interaction data such as gestures as the user interacts with a Web site. Interaction data can be leveraged to help identify the user and decrease unauthorized activities (e.g., e-commerce fraud). For example, during a purchase transaction, web server 370 can verify a user identity by analyzing interaction data against an established user behavior profile.

In step 205, application 372 on web server 370 establishes a browser session associated with a touchscreen interface 340. The browser session can be established in one or more traditional and/or proprietary manners. For example, application 372 can establish the browser session when a user authenticates via a login screen of a social networking Web site. In step 210, interaction data can be collected. In one instance, an input handler 333 on a computing device 310 can selectively collect interaction data based on device. For example, when a device includes a physical keyboard (e.g., QWERTY keyboard) and a virtual keyboard, interaction data can be optionally collected from both keyboards. In step 215, application 372 can initiate a privileged operation. Privileged operation can include any user initiated action associated with a user account.

In step 220, computing device 310 can convey the collected interaction data to an authentication entity, such as security engine 360 of authentication server 350. In step 225, the authentication entity can analyze a behavior pattern in the collected interaction data against a behavior pattern in a behavior profile. In step 230, authentication server 350 can generate a pattern matching score based on the analysis. The score can be a numerical value, non-numerical value, and the like. For example, the score can be a percentage value indicating the confidence at which the behavior pattern in the collected interaction data is similar to the behavior pattern in behavior profile. In step 235, application 372 can determine if the score is within a matching threshold. The matching threshold can be an administrator established value, system determined value, and the like. If it is determined at step 235 that the score is within the matching threshold, method 200 can continue to step 240 else proceed to step 245. In step 240, application 372 can execute the privileged operation. In step 245, application 372 can optionally convey, to touchscreen interface 340, a notification that the user identity cannot be confirmed. In step 250, application 372 can optionally convey a notification of authentication failure to relevant entities. For instance, application 372 can convey an email notification to an account manager of the Web site alerting the manager of an authentication failure associated with a user account. In step 255, if the browser session is optionally terminated, method 200 can continue to step 260, else proceed to step 210. In one embodiment, site protection program code can automatically terminate the browser session (e.g., logging the user out of the account and locking the account). In step 260, the method can end.

Drawings presented herein are for illustrative purposes only and should not be construed to limit the invention in any regard. Steps 210-255 can be continuously executed for the browser session enabling interaction data to be collected and evaluated to assist in positively identifying user identity. In one embodiment, interaction data can be continually collected and analyzed to establish various behavior baselines. For example, baselines for various activities such as searching (e.g., rapid scrolling, page changes) can be established.

The disclosure can be arbitrarily sophisticated, enabling flexible and robust user identification capabilities. For example, when a user is distracted by a task, typing errors can increase which can normally result in false authentication failures. To combat false negatives, one embodiment allows multiple baselines to be utilized to account for user emotional/mental state. In the embodiment, interaction data can be evaluated against different behavior profiles based on criteria (e.g., time of day, geographic location). It should be appreciated that method 200 can be a portion of an authentication scheme. It should be understood that steps 210-255 can be performed in parallel or in serial. Further, method 200 can be performed in real-time or near real-time.

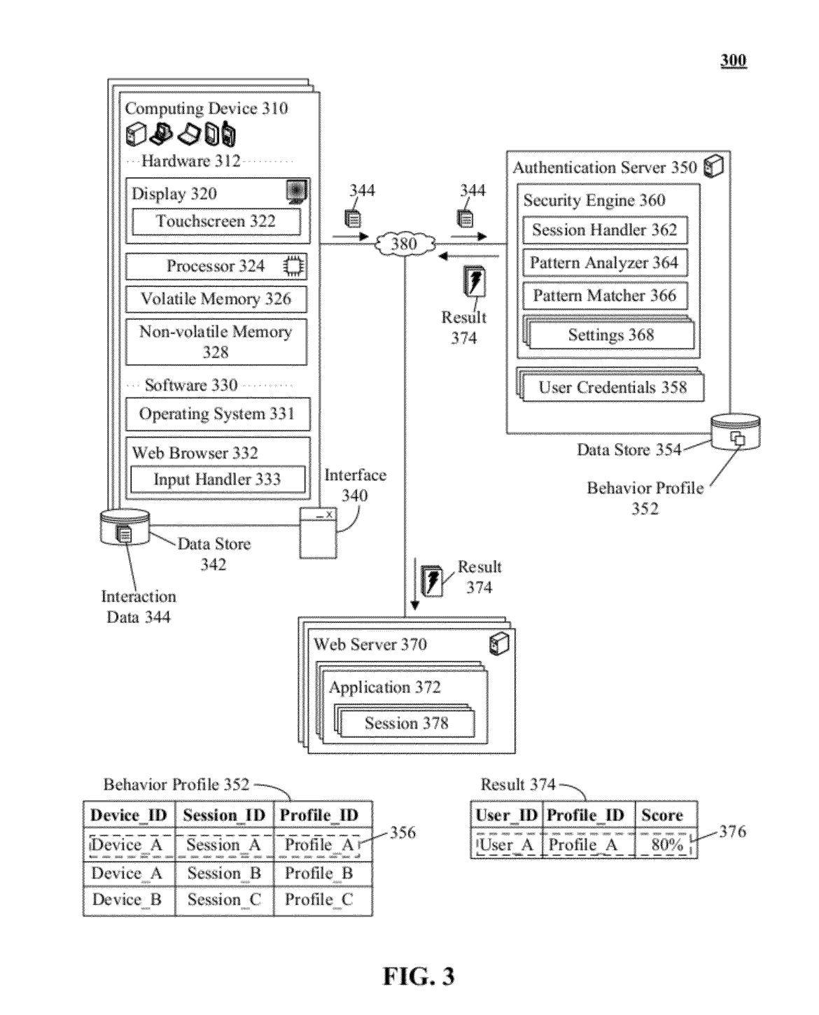

FIG. 3 is a schematic diagram illustrating a system 300 for transparently determining user identity based on data of user interactions with a touchscreen-equipped device during a browser session in accordance with an embodiment of the inventive arrangements disclosed herein. System 300 can be present in the context of processes 105, 140 and/or method 200. In system 300, a security engine 360 can permit enhanced user authentication utilizing pattern matching between a behavior pattern in interaction data 344 and a behavior pattern in behavior profile 352. Interaction data 344 can be collected by input handler 333 via interface 340. Interaction data 344 can be communicated via network 380 to authentication server 350. Server 350 can utilize user credentials 358 (e.g., login information) in conjunction with behavior profile 352 to verify user identity. Authentication server 350 can communicate the result 374 of user identity verification to application 372.

In one instance, computing device 310 can communicate interaction data 344 to relevant entities via an Asynchronous Javascript and Extensible Markup Language (AJAX) procedure. In the instance, computing device 310 can utilize an Extensible Markup Language HyperText Markup Language (XMLHTTP) procedure to communicate data 344 in real-time or near real-time.

As used herein, display 320 can be a hardware element comprising touchscreen 322. Display 320 can be a visual display permitting the presentation of interface 340 within touchscreen 322. Touchscreen 322 can include, but is not limited to, resistive technologies, capacitive technologies, surface acoustic wave technologies, and the like. In one embodiment, touchscreen 322 can present Web browser 332 which can be associated with interface 340. In another embodiment, touchscreen 322 can present a Web-enabled application with session capabilities. As input handler 333 collects interaction data 344, computing device 310 can store data 344 within data store 342.

Web browser 332 can be for retrieving, presenting, and traversing information resources on the World Wide Web. An information resource can be identified by a Uniform Resource Identifier (URI) and can be a Web page, image, video, or other digital content. Browser 332 can include, but is not limited to, input handler 333, renderable canvas (not shown), a rendering engine, and the like. Browser 332 can be, for example, FIREFOX®, GOOGLE CHROME™, SAFARI®, and OPERA™ (Firefox® is a registered trademark of Mozilla Foundation in the United States; Google Chrome™ is a trademark of Google Inc. in the United States; Safari® is a registered trademark of Apple Inc. in the United States; and Opera™ is a trademark of Opera Software ASA in the United States).

Input handler 333 can be a software component for detecting and logging interaction data. Computing device 310 can utilize handler 333 to detect user interaction associated with pressure, position, duration, and the like. In one embodiment, handler 333 can detect different pointing tools, including, but not limited to a finger, multiple fingers, a stylus, and the like. Handler 333 can store interaction data associated with a session 378 within data store 342 as interaction data 344.

Authentication server 350 can be a hardware/software element for processing interaction data 344 and producing result 374. Server 350 can include a set of server components 351, which includes hardware 380 and software/firmware 387. Authentication server 350 can have built-in redundancy, high performance, and support for complex database access. Server 350 can include, but is not limited to, security engine 360, data store 354, user credentials 358, and the like. In one instance, server 350 can be associated with a middleware software entity. In the instance, server 350 can be an IBM WEBSPHERE COMMERCE® server (WEBSPHERE® is a registered trademark of International Business Machines Corporation in the United States). It should be appreciated that server 350 can be a distributed computing element. For example, server 350 functionality can be a software-as-a-service (SaaS) Web-enabled service.

Engine 360 can be a hardware/software entity able to authenticate a user based on behavior profile 352. Engine 360 can include, but is not limited to, session handler 362, pattern analyzer 364, pattern matcher 366, settings 368, user credentials 358, and the like. In one instance, engine 360 functionality can be encapsulated within an application programming interface (API). In one embodiment, engine 360 can be a network element within a service oriented architecture (SOA). For example, engine 360 can function as a Web service transparently performing authentication actions for application 372. In one embodiment, engine 360 can be a component of server 370.

Session handler 362 can be a hardware/software component for tracking browser sessions. Handler 362 functionality can include session commencement, session termination, session tracking, device tracking, user account identification, and the like. Engine 360 can utilize handler 362 to associate interaction data 344 with user credentials 358. In one instance, handler 362 can track sessions across multiple computing devices, multiple applications 372, and the like. In the instance, handler 362 can utilize hardware and/or software information including, but not limited to, an identifier of a processor 324, a class of processor 324, a version of an operating system 331, a version of browser 332 (e.g., major, minor), browser codename, cookies, Internet Protocol (IP) address subnet, platform (e.g., operating system 331), user agent, system language, and the like. In one configuration of the instance, information can be associated with weighting values permitting rapid detection of device 310 usage. For example, IP address subnet can have a positive weighting allowing device network location to quickly identify device 310. In one embodiment, handler 362 can request interaction data 344 for a current e-commerce session (e.g., session 378). In another embodiment, handler 362 can request interaction data 344 for a historic e-commerce session.

Pattern analyzer 364 can be a hardware/software entity for evaluating behavior patterns associated with interaction data 344. Analyzer 364 functionality can include, but is not limited to, pattern detection, data mining, data scrubbing, and the like. In one embodiment, analyzer 364 can be used to select specific types of interaction data 344 for evaluation. For example, engine 360 can utilize analyzer 364 to select gesture behaviors to be examined by matcher 366. In one embodiment, analyzer 364 can heuristically determine behavior characteristics of importance. For example, although many users can have similar interaction patterns with device 310, users' idiosyncrasies can be determined, which in turn can uniquely identify the user. In one instance, analyzer 364 can identify and catalog idiosyncrasies which can be utilized to quickly determine user identity. For example, a behavior “fingerprint” can be created for each user permitting rapid assessment of user authorization.

Pattern matcher 366 can be a hardware/software component for confirming user identity based on data 344 and profile 352. Matcher 366 functionality can include, but is not limited to, pattern matching, partial matching, pattern recognition, and the like. In one instance, matcher 366 can produce a pattern matching score which can be utilized by application 372 to verify user identity. In one embodiment, matcher 366 can generate result 374 which authentication server 350 can convey to application 372. In one instance, authorization can be determined within matcher 366 based on a pattern matching ruleset. In the instance, matcher 366 of authentication server 350 can evaluate a pattern matching score against one or more thresholds (e.g., within a ruleset) to confirm a user identity.

Settings 368 can be one or more configuration options for establishing the behavior of system 300 and/or engine 360. Settings 368 can include, but are not limited to, session handler 362 options, pattern analyzer 364 parameters, pattern matcher 366 configuration settings, profile 352 settings, and the like. In one embodiment, settings 368 can specify security protocols which can protect system 300. For example, settings can specify encryption schemes which can be employed by computing device 310, server 350, and server 370 to secure data 344 and/or result 374 in transit.

Behavior profile 352 can be a data set including behavior patterns during use of computing device 310 for an e-commerce session and/or accessing a user account. Behavior profile 352 can include, but is not limited to, a device identifier, a session identifier, a user profile, a user account, and the like. Profile 352 can include a baseline behavior characterization, a non-baseline characterization, and the like. For instance, profile 352 can support multiple profiles for a user based on device type. Device to profile tracking can be enabled utilizing entry 356 which can link a device identifier (e.g., Device_A) to a profile identifier (e.g., Profile_A). It should be appreciated that profile 352 can be arbitrarily complex permitting support of any detectable behavior in use of computing device 310.

Result 374 can be a data set associated with data 344 and profile 352 evaluation. Result 374 can include, but is not limited to, a user identifier, a profile identifier, a score (e.g., pattern matching score), and the like. For example, result 374 can include data 376 which can provide authentication information for a User_A indicating interaction data matches Profile_A by eighty percent. In one instance, result 374 can conform to a traditional authentication response which can be processed by application 372. For example, when authentication fails, security engine 360 can convey an error code within result 374.

Web server 370 can be a hardware/software element for executing application 372. Server 370 can include a set of server components 371, which includes hardware 380 and software/firmware 387. Web server 370 can have built-in redundancy, high performance, and support for complex database access. Server 372 can include, but is not limited to, application 372, application 372 settings, and the like. In one instance, server 370 can be associated with an IBM WEBSPHERE APPLICATION® server (WEBSPHERE® is a registered trademark of International Business Machines Corporation in the United States). Server 372 can include multiple servers which can be geographically distributed.

Application 372 can be a Web-based application permitting one or more privileged operations to be performed. Application 372 can include session 378 which can be associated with browser 332. In one instance, session 372 can be an e-commerce session. Application 372 can be a client-based application (e.g., rich internet application), server based application, and the like. For example, application 372 can be a business-to-business e-commerce application permitting electronic fund transfers.

Each of the server components 351, 371 can include one or more processors 382, one or more computer-readable memories 382, and one or more computer-readable tangible storage devices 385, which are connected via a bus 384. Within each of the servers 350, and 370, program instructions (e.g., software/firmware 387) can be stored on at least one of the one or more storage devices 385 for execution by at least one of the one or more processors 382 via at least one of the one or more memories 383. Software/firmware 387 can include any one or more of application 372, security engine 360, session handler 362, pattern analyzer 364, pattern matcher 366, and the like.

Computing device 310 can be an electronic device having touchscreen 322. Device 310 can include hardware 312, software 330, firmware, and the like. Hardware 312 can include, but is not limited display 320, processor 324, volatile memory 326, non-volatile memory 328, data store 342, and the like. Software 330 can include operating system 331, browser 332, interface 340, and the like. Embodiments of device 310 can include, but are not limited to, a mobile phone, a laptop, a tablet computing device, a desktop computer, a portable media player, a portable gaming system, and the like. It should be appreciated that Web browser 332 can be an optional component and can be substituted with a client-side application with e-commerce capabilities.

Interface 340 can be a user interactive component permitting interaction with display 320. Interface 340 can present Web browser 332, a desktop application, and the like. Interface 340 capabilities can include a graphical user interface (GUI), voice user interface (VUI), mixed-mode interface, and the like. Interface 340 can be communicatively linked to computing device 310.

Data stores 342, 354 can be a hardware/software component able to store data 344 and behavior profile 354, respectively. Data stores 342, 354 can each be a Storage Area Network (SAN), Network Attached Storage (NAS), and the like. Data stores 342, 354 can each conform to a relational database management system (RDBMS), object oriented database management system (OODBMS), and the like. Data stores 342, 354 can be communicatively linked to computing device 310 and server 350, respectively, in one or more traditional and/or proprietary mechanisms

Network 380 can be an electrical and/or computer network connecting one or more system 200 components. Network 380 can include, but is not limited to, twisted pair cabling, optical fiber, coaxial cable, and the like. Network 380 can include any combination of wired and/or wireless components. Network 380 topologies can include, but are not limited to, bus, star, mesh, and the like. Network 380 types can include, but are not limited to, Local Area Network (LAN), Wide Area Network (WAN), Virtual Private Network (VPN) and the like.

Drawings presented herein are for illustrative purposes only and should not be construed to limit the invention in any regard. The disclosure can be associated with any traditional and/or proprietary authentication scheme including, but not limited to, private key cryptography, public key cryptography, and the like. It should be appreciated that system 300 can represent one embodiment of the disclosure and actual implementation characteristics can vary. System 300 can be a component of a networked computing architecture, a distributed computing environment, a cloud computing environment, and the like.

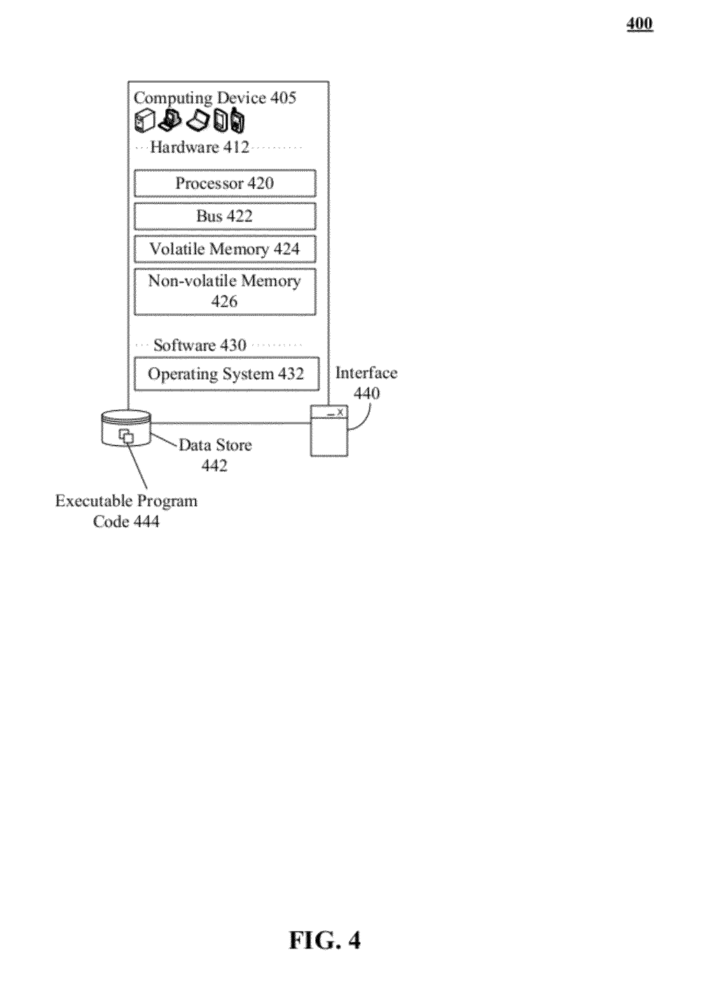

FIG. 4 is a schematic diagram illustrating an exemplary computing device 405 in accordance with an embodiment of the inventive arrangements disclosed herein. Computing device 405 can be a programmable machine designed to sequentially and automatically carry out a sequence of arithmetic or logical operations. Device 405 can include hardware 412, software 430, firmware, and the like. Hardware 412 can include, but is not limited processor 420, bus 422, volatile memory 424, non-volatile memory 426, data store 442, and the like. Software 430 can include operating system 432, interface 440, and the like. Software 430 can include executable program code 444 stored within machine readable data store 442. Executable program code 444 can be one or more algorithms for performing operations described within the disclosure. Executable program code 444 can be executed within operating system 432, a firmware, and the like. Device 405 can include, but is not limited to, a server computing device, a network computing element, and the like. Device 405 can be an example of server 350 and/or server 370.

The flowchart and block diagrams in the FIGS. 1-4 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for detecting fraudulent user interactions with a touchscreen-equipped electronic device, the method comprising the steps of:
a processor receiving data indicative of interactions between the user and the touchscreen-equipped electronic device;
the processor comparing a behavior pattern in the received data and a behavior pattern in previously stored data contained within a user profile for a human;
the processor generating a score indicative of a likelihood that the behavior pattern in the received data matches the behavior pattern in the previously stored data; and
responsive to the generated score being below a threshold, the processor generating an indication of a possible fraudulent action due to the user having a high likelihood of not being the human.

2. The method of claim 1, further comprising:
the processor receiving a request from the user for a privileged operation;
responsive to the generated score being below the threshold, the processor denying the request for the privileged operation.

3. The method of claim 2, wherein the privileged operation is associated with a user account of the human.

4. The method of claim 1, further comprising:
before the comparing step, the processor authenticating the user as the human utilizing a user-provided username value and password.

5. The method of claim 1, wherein the behavior pattern in the received data comprises a pattern of idiosyncratic behavior of the user in providing input to the touchscreen-equipped electronic device, and wherein the comparing step comprises comparing the pattern of idiosyncratic behavior against a pattern of idiosyncratic behavior in the behavior pattern in the previously stored data.

6. The method of claim 1, wherein the interactions between the user and the touchscreen-equipped electronic device include at least one of a zoom gesture, a scroll gesture, a typing rate, a typing style, a hand preference, and a screen orientation.

7. The method of claim 1, wherein the interactions between the user and the touchscreen-equipped electronic device include an interaction with a user interface on the touchscreen-equipped electronic device.

8. The method of claim 7, wherein the user interface is a user interface of a web browser.

9. The method of claim 1, wherein the touchscreen-equipped computing device includes the processor.

10. The method of claim 1, wherein a server remotely located from the touchscreen-equipped computing device includes the processor.

11. The method of claim 1, wherein the privileged operation is an e-commerce transaction, and wherein the e-commerce transaction is a single action shopping purchase.

12. The method of claim 1, further comprising the step of:
the processor establishing a baseline behavior associated with the touchscreen-equipped computing device.

13. The method of claim 1, wherein said user profile is a behavioral representation associated with a user identity, and wherein said behavior representation is specified using behavioral biometrics.

14. The method of claim 1, further comprising:
responsive to the processor generating the indication of the possible fraudulent action, the processor terminating an attempted commerce transaction involving the user being conducted via the touchscreen-equipped computing device.

15. The method of claim 1, further comprising:
responsive to the processor generating the indication of the possible fraudulent action, the processor generating a requirement that the user to provide additional authentication information to verify that the user is the human.

16. The method of claim 1, further comprising:
responsive to the processor generating the indication of the possible fraudulent action, the processor alerting the human of the possible fraudulent action.

17. A computer system for detecting fraudulent user interactions with a touchscreen-equipped electronic device, said computer system comprising:
one or more processors, one or more computer-readable memories and one or more computer-readable tangible storage devices;
program instructions, stored on at least one of the one or more storage devices for execution by at least one of the one or more processors via at least one of the one or more memories, to receive data indicative of interactions between the user and the touchscreen-equipped electronic device;
program instructions, stored on at least one of the one or more storage devices for execution by at least one of the one or more processors via at least one of the one or more memories, to compare a behavior pattern in the received data and a behavior pattern in previously stored data contained within a user profile for a human;
program instructions, stored on at least one of the one or more storage devices for execution by at least one of the one or more processors via at least one of the one or more memories, to generate a score indicative of a likelihood that the behavior pattern in the received data matches the behavior pattern in the previously stored data; and
program instructions, stored on at least one of the one or more storage devices for execution by at least one of the one or more processors via at least one of the one or more memories, responsive to the generated score being below a threshold, to generate an indication of a possible fraudulent action due to the user having a high likelihood of not being the human.

18. The computer system of claim 17, further comprising:
program instructions, stored on at least one of the one or more storage devices for execution by at least one of the one or more processors via at least one of the one or more memories, to receive a request from the user for a privileged operation;
program instructions, stored on at least one of the one or more storage devices for execution by at least one of the one or more processors via at least one of the one or more memories, responsive to the generated score being below the threshold, to deny the request for the privileged operation.

19. A computer program product detecting fraudulent user interactions with a touchscreen-equipped electronic device, the computer program product comprising:
one or more computer-readable tangible storage devices;
program instructions, stored on at least one of the one or more storage devices, to receive data indicative of interactions between the user and the touchscreen-equipped electronic device;
program instructions, stored on at least one of the one or more storage devices, to compare a behavior pattern in the received data and a behavior pattern in previously stored data contained within a user profile for a human;
program instructions, stored on at least one of the one or more storage devices, to generate a score indicative of a likelihood that the behavior pattern in the received data matches the behavior pattern in the previously stored data; and
program instructions, stored on at least one of the one or more storage devices, responsive to the generated score being below a threshold, to generate an indication of a possible fraudulent action due to the user having a high likelihood of not being the human.

20. The computer program product of claim 18, further comprising:
program instructions, stored on at least one of the one or more storage devices, to receive a request from the user for a privileged operation;
program instructions, stored on at least one of the one or more storage devices, to deny the request for the privileged operation.
